(19) United States
(12) Patent Application Publication
(10) Pub. No.: US 2026/0107351 A1
(43) Pub. Date: Apr. 16, 2026

(54) MICROWAVE HEATING DEVICE

(71) Applicant: SHARP KABUSHIKI KAISHA, Sakai City, Osaka (JP)

(72) Inventors: YOSHINOBU TOMOMURA, Sakai City, Osaka (JP); MASATO SASAKI, Sakai City, Osaka (JP)

(21) Appl. No.: 19/116,018

(22) PCT Filed: Dec. 27, 2022
(86) PCT No.: PCT/JP2022/048065

§ 371 Date: Mar. 27, 2025

(51) Int. Cl. H05B 6/64

(52) U.S. Cl. CPC H05B 6/64

(57) ABSTRACT

A microwave heating device includes: a housing having a transmitting portion that transmits a microwave; a microwave emitting portion that is provided in a manner facing the transmitting portion outside the housing and configured to emit a microwave; and a conductive member provided between the transmitting portion and the microwave emitting portion.

### TECHNICAL FIELD

The present invention relates to a microwave heating device.

### BACKGROUND ART

Conventionally, a microwave heating device for heating an object to be heated using microwaves is known (see, for example, Patent Literature 1).

### CITATION LIST

### Patent Literature

Patent Literature 1: JP 2009-016149 A

### SUMMARY OF INVENTION

### Technical Problem

However, in the conventional microwave heating device, heating unevenness may occur in an object to be heated.

In view of the above, an object of one aspect of the present invention is to provide a microwave heating device capable of suppressing heating unevenness of an object to be heated.

### Solution to Problem

A microwave heating device according to one aspect of the present invention includes a housing having a transmitting portion that transmits microwaves, a microwave emitting portion that is provided outside the housing so as to face the transmitting portion and emits microwaves, and a conductive member provided between the transmitting portion and the microwave emitting portion.

### BRIEF DESCRIPTION OF DRAWINGS

FIG. 1 is a perspective view of a heating cooker according to a first embodiment.

FIG. 2 is a perspective view illustrating a state in which a door is opened in the heating cooker.

FIG. 3 is a schematic diagram illustrating an internal configuration of the heating cooker.

FIG. 4A is a perspective view of the heating cooker illustrating a planar antenna and a first conductive member.

FIG. 4B is a cross-sectional view of the heating cooker illustrating the planar antenna and the first conductive member.

FIG. 4C is a top view of the planar antenna and the first conductive member.

FIG. 5A is a perspective view illustrating an analysis result of electric field distribution on an upper surface of an object to be heated when the object to be heated is heated in the heating cooker.

FIG. 5B is a top view illustrating an analysis result of electric field distribution on an upper surface of an object to be heated when the object to be heated is heated in the heating cooker.

FIG. 6A is a perspective view illustrating an analysis result of electric field distribution on an upper surface of an object to be heated when the object to be heated is heated in a mode in which the first conductive member is removed from the heating cooker.

FIG. 6B is a top view illustrating an analysis result of electric field distribution on an upper surface of an object to be heated when the object to be heated is heated in a mode in which the first conductive member is removed from the heating cooker.

FIG. 7A is a diagram illustrating a first variation of the first conductive member.

FIG. 7B is a diagram illustrating a second variation of the first conductive member.

FIG. 7C is a diagram illustrating a third variation of the first conductive member.

FIG. 7D is a diagram illustrating a fourth variation of the first conductive member.

FIG. 7E is a diagram illustrating a fifth variation of the first conductive member.

FIG. 7F is a diagram illustrating a sixth variation of the first conductive member.

FIG. 7G is a diagram illustrating a seventh variation of the first conductive member.

FIG. 7H is a diagram illustrating an eighth variation of the first conductive member.

FIG. 8 is a top view of the planar antenna and the first conductive member in the heating cooker according to a second embodiment.

FIG. 9A is a temperature distribution diagram of an upper surface of an object to be heated when the object to be heated is heated at a predetermined temperature for predetermined time in the heating cooker according to the second embodiment.

FIG. 9B is a temperature distribution diagram of a bottom surface of an object to be heated when the object to be heated is heated at a predetermined temperature for predetermined time in the heating cooker according to the second embodiment.

FIG. 10 is a temperature distribution diagram of an upper surface of an object to be heated when the object to be heated is heated at a predetermined temperature for predetermined time in a mode in which the first conductive member is removed from the heating cooker of the second embodiment.

FIG. 11A is a perspective view of the heating cooker according to a third embodiment illustrating the planar antenna and a second conductive member.

FIG. 11B is a cross-sectional view of the heating cooker according to the third embodiment illustrating the planar antenna and the second conductive member.

FIG. 11C is a top view of the planar antenna and the second conductive member.

FIG. 12A is a perspective view illustrating an analysis result of electric field distribution on an upper surface of an object to be heated when the object to be heated is heated in the heating cooker according to the third embodiment.

FIG. 12B is a top view illustrating an analysis result of electric field distribution on an upper surface of an object to be heated when the object to be heated is heated in the heating cooker according to the third embodiment.

FIG. 13A is a diagram illustrating a first variation of the second conductive member.

FIG. 13B is a diagram illustrating a second variation of the second conductive member.

FIG. 13C is a diagram illustrating a third variation of the second conductive member.

FIG. 13D is a diagram illustrating a fourth variation of the second conductive member.

FIG. 13E is a diagram illustrating a fifth variation of the second conductive member.

FIG. 13F is a diagram illustrating a sixth variation of the second conductive member.

FIG. 13G is a diagram illustrating a seventh variation of the second conductive member.

FIG. 13H is a diagram illustrating an eighth variation of the second conductive member.

FIG. 13I is a diagram illustrating a ninth variation of the second conductive member.

FIG. 13J is a diagram illustrating a tenth variation of the second conductive member.

### DESCRIPTION OF EMBODIMENTS

Hereinafter, embodiments of the present disclosure will be described with reference to the drawings. Note that, in the drawings, the same or equivalent elements are denoted by the same reference signs, and redundant description is omitted.

In the present embodiment, a heating cooker as an example of a microwave heating device will be described as an example. The heating cooker performs dielectric heating of an object A to be heated such as food by using an electromagnetic wave at a frequency of 2.4 GHz or more and 2.5 GHz or less which is a UHF band frequency. However, the frequency of an electromagnetic wave used in the microwave heating device of the present invention is not limited to this.

### First Embodiment

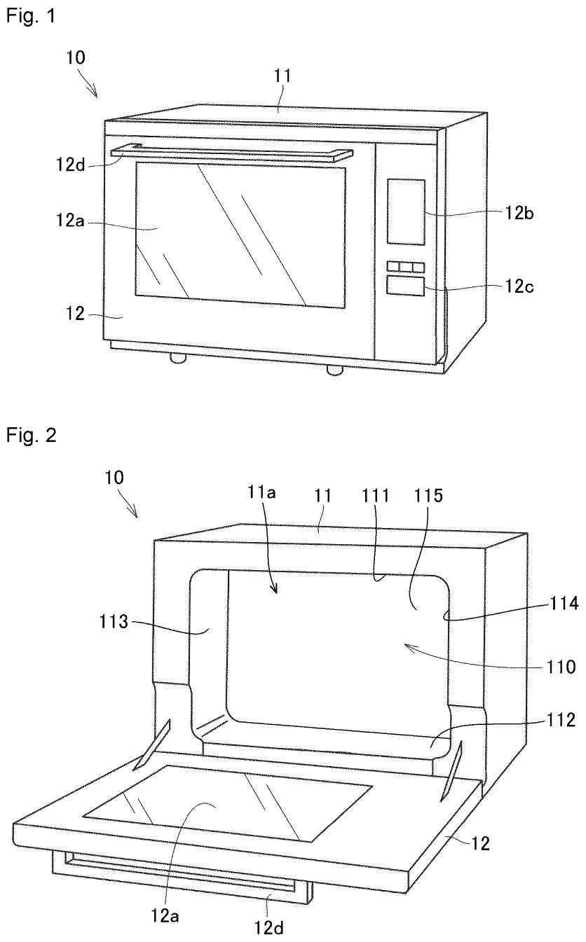

An overall configuration of a heating cooker 10 according to a first embodiment will be described with reference to FIGS. 1 and 2. FIG. 1 is a perspective view of the heating cooker 10. FIG. 2 is a perspective view illustrating a state in which a door 12 is opened in the heating cooker 10. Hereinafter, a side on which an opening portion 11a of a cooker main body 11 to be described later is provided is referred to as a front side, an opposite side of the front side is referred to as a rear side, a side on which the cooker main body 11 to be described later is placed is referred to as a lower side, and an opposite side of the lower side is referred to as an upper side.

The heating cooker 10 includes the cooker main body 11 and the door 12. The cooker main body 11 has a heating cooking function. The opening portion 11a is provided on a front surface of the cooker main body 11. The door 12 is provided to be able to open and close the opening portion 11a of the cooker main body 11. The door 12 includes a viewing window 12a through which the inside can be visually recognized from the outside, a display unit 12b capable of displaying various types of information, an operation unit 12c capable of receiving various types of operation, and a grip unit 12d for opening and closing the door 12.

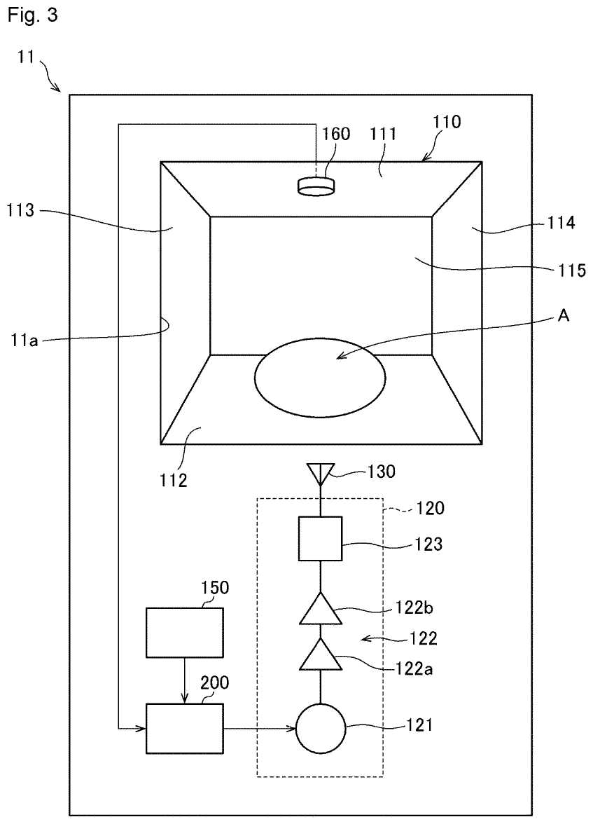

An internal configuration of the heating cooker 10 will be described with reference to FIG. 3. FIG. 3 is a schematic diagram illustrating an internal configuration of the heating cooker 10.

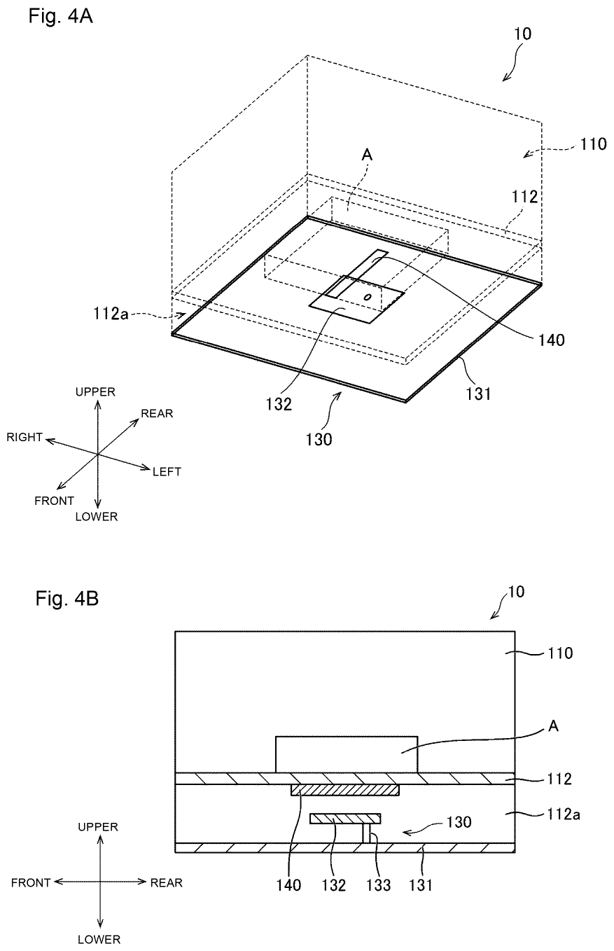

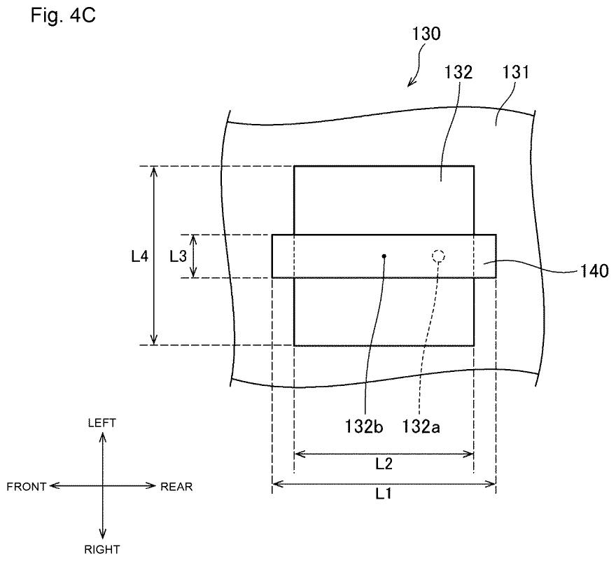

As illustrated in FIG. 3, the cooker main body 11 includes a housing 110, a microwave generation unit 120, a planar antenna 130, a first conductive member 140 (see FIG. 4), an opening and closing detection unit 150, a temperature detection unit 160, and a control unit 200.

The housing 110 is a space for housing the object A to be heated through the opening portion 11a. The housing 110 is a space surrounded by an upper wall portion 111, a lower wall portion 112, a left wall portion 113, a right wall portion 114, and a rear wall portion 115. When the opening portion 11a is closed by the door 12, the housing 110 becomes a closed space. The housing 110 is formed of a metal member except for the lower wall portion 112.

The lower wall portion 112 is configured as a transmitting portion that transmits microwaves. The lower wall portion 112 is formed of, for example, a member that transmits microwaves, such as glass, ceramic, Neoceram, or resin. Further, the lower wall portion 112 functions as a heat-resistant plate on which the object A to be heated is placed.

In the present embodiment, the entire lower wall portion 112 is configured as a transmitting portion, but the present invention is not limited to this, and a part of the lower wall portion 112 may be configured as a transmitting portion. Further, in the present embodiment, the lower wall portion 112 is configured as a transmitting portion, but the present invention is not limited to this, and an optional wall portion (for example, the upper wall portion 111, the lower wall portion 112, the left wall portion 113, the right wall portion 114, the rear wall portion 115, and the like) constituting the housing 110 may be configured as a transmitting portion.

The microwave generation unit 120 generates microwaves for heating the object A to be heated in the housing 110. The microwave generation unit 120 is arranged inside the cooker main body 11, for example, below a transmitting portion (the lower wall portion 112) of the housing 110.

The microwave generation unit 120 includes an oscillation unit 121, an amplification unit 122, and a power detection unit 123.

The oscillation unit 121 generates high-frequency power at a frequency of 2.4 GHz or more and 2.5 GHz or less. The oscillation unit 121 has, for example, a variable voltage frequency function of a variable voltage type.

The amplification unit 122 amplifies high-frequency power output from the oscillation unit 121. The amplification unit 122 is arranged between the oscillation unit 121 and the power detection unit 123.

The amplification unit 122 includes a first amplification unit 122a and a second amplification unit 122b. The first amplification unit 122a is arranged between the oscillation unit 121 and the second amplification unit 122b. The first amplification unit 122a amplifies high-frequency power output from the oscillation unit 121. The second amplification unit 122b is arranged between the first amplification unit 122a and the power detection unit 123. The second amplification unit 122b amplifies high-frequency power amplified by the first amplification unit 122a.

The power detection unit 123 detects a power value of high-frequency power supplied to the planar antenna 130. The power detection unit 123 is arranged between the second amplification unit 122b and the planar antenna 130.

Note that, in the present embodiment, the amplification unit 122 amplifies a high-frequency signal stepwise by two amplification units, but the present invention is not limited to this, and the amplification unit 122 may amplify high-frequency power by using one amplification unit or three or more amplification units.

The planar antenna 130 emits microwaves generated by the microwave generation unit 120 to the housing 110. The planar antenna 130 is provided facing a transmitting portion (the lower wall portion 112) inside the cooker main body 11, more specifically, outside the housing 110. That is, the planar antenna 130 is arranged below the transmitting portion (lower wall portion 112).

Note that the planar antenna 130 only needs to be provided facing a transmitting portion outside the housing 110, and for example, in a case where a transmitting portion is provided in the upper wall portion 111, the planar antenna 130 only needs to be arranged above the transmitting portion (upper wall portion 111), in a case where a transmitting portion is provided in the left wall portion 113, the planar antenna 130 only needs to be arranged on the left side of the transmitting portion (left wall portion 113), in a case where a transmitting portion is provided in the right wall portion 114, the planar antenna 130 only needs to be arranged on the right side of the transmitting portion (right wall portion 114), and in a case where a transmitting portion is provided in the rear wall portion 115, the planar antenna 130 only needs to be arranged behind the transmitting portion (rear wall portion 115).

In the present embodiment, a housing 112a that houses the planar antenna 130 is provided below the lower wall portion 112 (transmitting portion) (see FIG. 4). The housing 112a is a space surrounded by the lower wall portion 112 and a wall surface formed by a metal member.

The planar antenna 130 emits microwaves into the housing 110 via a transmitting portion (lower wall portion 112). A detailed configuration of the planar antenna 130 will be described later.

The first conductive member 140 acts on microwaves emitted by the planar antenna 130 to adjust electric field intensity in the housing 110. A detailed configuration of the first conductive member 140 will be described later.

The opening and closing detection unit 150 detects opening and closing of the door 12. The opening and closing detection unit 150 is provided at a contact portion between the cooker main body 11 and the door 12 when the door 12 is closed. The opening and closing detection unit 150 is, for example, a limit switch. Note that the opening and closing detection unit 150 is not limited to a physical sensor such as a limit switch, and an optical sensor or the like may be used.

The temperature detection unit 160 detects temperature of the object A to be heated housed in the housing 110. The temperature detection unit 160 is arranged on the upper wall portion 111 of the housing 110.

A control unit 200 is connected to various components of the heating cooker 10. The control unit 200 is connected to, for example, the microwave generation unit 120, the opening and closing detection unit 150, and the temperature detection unit 160. The control unit 200 performs control such as adjustment of high-frequency power generated from the oscillation unit 121 and termination of heating based on a detection result of the temperature detection unit 160. Further, the control unit 200 controls the oscillation unit 121 based on a detection result of the opening and closing detection unit 150. For example, when the door 12 is opened, the control unit 200 stops the oscillation unit 121.

The planar antenna 130 and the first conductive member 140 will be described with reference to FIG. 4. FIG. 4A is a perspective view of the heating cooker 10 illustrating the planar antenna 130 and the first conductive member 140. In FIG. 4A, a member other than the planar antenna 130 and the first conductive member 140 is indicated by a broken line. In FIG. 4A, the door 12 is not illustrated. FIG. 4B is a cross-sectional view of the heating cooker 10 illustrating the planar antenna 130 and the first conductive member 140. FIG. 4B is a cross-sectional view taken along a vertical plane passing through the first conductive member 140 along a front-rear direction. FIG. 4C is a top view of the planar antenna 130 and the first conductive member 140. Hereinafter, a direction in which a transmitting portion (the lower wall portion 112) and the planar antenna 130 face each other (in the present embodiment, an up-down direction) is referred to as a first direction. In other words, a direction in which a transmitting portion (the lower wall portion 112) and the planar antenna 130 face each other is a direction in which a transmitting portion (the lower wall portion 112) and the planar antenna 130 are aligned.

The planar antenna 130 includes a ground electrode 131 and an emitting electrode 132. The ground electrode 131 and the emitting electrode 132 are provided at intervals in the first direction (in the present embodiment, the up-down direction). The emitting electrode 132 is supported by, for example, a plurality of pillars provided on the ground electrode 131. A power supply cable 133 is connected to the planar antenna 130. An outer conductor of the power supply cable 133 is connected to the ground electrode 131 and has ground potential. An inner conductor of the power supply cable 133 is connected to a power supply point 132a (see FIG. 4C) of the emitting electrode 132.

The ground electrode 131 is formed in a flat plate shape. The ground electrode 131 is formed of a metal material such as copper. In the present embodiment, the ground electrode 131 has a rectangular shape when viewed from the first direction (in the present embodiment, the up-down direction).

The emitting electrode 132 is formed in a flat plate shape. The emitting electrode 132 is formed of a metal material such as copper. In the present embodiment, the emitting electrode 132 has a square shape when viewed from the first direction (in the present embodiment, the up-down direction). In a case where the planar antenna 130 is used to emit an electromagnetic wave having a wavelength λ, a shape of the emitting electrode 132 is preferably a square having a side length of λ/2. For example, since the wavelength λ of microwaves at a frequency of 2.45 GHz is about 122 mm, the emitting electrode 132 is preferably formed in a square whose one side is about 61 mm which is λ/2.

Note that the emitting electrode 132 has a square shape when viewed from the first direction (in the present embodiment, the up-down direction), but is not limited to this, and may have a polygonal shape (for example, a rectangular shape), a circular shape, or an elliptical shape. Further, although the planar antenna 130 has a space between the ground electrode 131 and the emitting electrode 132, the present invention is not limited to this, and a dielectric may be provided between the ground electrode 131 and the emitting electrode 132.

The first conductive member 140 acts on microwaves emitted by the planar antenna 130 to adjust electric field intensity in the housing 110. In the present embodiment, one of the first conductive member 140 is provided for one of the emitting electrode 132.

The first conductive member 140 is a flat plate having an elongated shape. The first conductive member 140 is formed of, for example, copper. Note that the first conductive member 140 is formed of copper, but is not limited to this, and may be formed of a metal material such as aluminum.

The first conductive member 140 is provided between the planar antenna 130 and a transmitting portion (the lower wall portion 112). In the present embodiment, the first conductive member 140 is fixed to a lower surface of the transmitting portion (lower wall portion 112) with an adhesive member such as Kapton tape. Note that the first conductive member 140 is fixed to the transmitting portion (lower wall portion 112) using an adhesive member such as Kapton tape, but is not limited to this, and may be supported by the transmitting portion (lower wall portion 112) with a support member, or may be mechanically connected to the transmitting portion (lower wall portion 112). Further, although the first conductive member 140 is fixed to the transmitting portion (lower wall portion 112), the present invention is not limited to this, and the first conductive member 140 may be fixed to the planar antenna 130 with a support member with a space between them.

As illustrated in FIG. 4C, the first conductive member 140 is arranged to overlap a part of the emitting electrode 132 when viewed from the first direction (in the present embodiment, the up-down direction). Size (area) of the first conductive member 140 is smaller than size (area) of the emitting electrode 132.

Specifically, the first conductive member 140 has a shape whose longitudinal direction is a polarization direction of the planar antenna 130. The polarization direction of the planar antenna 130 is a direction determined based on the power supply point 132a of the emitting electrode 132. Specifically, the polarization direction of the planar antenna 130 is a direction in which a center portion 132b of the emitting electrode 132 and the power supply point 132a of the emitting electrode 132 are aligned when viewed from the up-down direction. In the present embodiment, the polarization direction of the planar antenna 130 is a front-rear direction. That is, the first conductive member 140 has a shape whose longitudinal direction is the front-rear direction.

Note that the shape whose longitudinal direction is a polarization direction of the planar antenna 130 only needs to be a shape in which the longitudinal direction extends in the front-rear direction that is substantially the polarization direction, and includes a shape in which the longitudinal direction extends in a direction parallel to the front-rear direction and a shape in which the longitudinal direction extends in a direction slightly inclined with respect to the front-rear direction.

Further, the first conductive member 140 is provided to cross from one end portion (in the present embodiment, a front end portion) to another end portion (in the present embodiment, a rear end portion) in a polarization direction of the emitting electrode 132. That is, length L1 in a longitudinal direction (in the present embodiment, in the front-rear direction) of the first conductive member 140 is longer than length L2 in a longitudinal direction (in the present embodiment, in the front-rear direction) of the emitting electrode 132.

Further, the emitting electrode 132 is provided to extend on both sides in a lateral direction (in the present embodiment, a left-right direction) of the first conductive member 140. Further, length L3 in a lateral direction (in the present embodiment, in the left-right direction) of the first conductive member 140 is shorter than length L4 in a lateral direction (in the present embodiment, the left-right direction) of the emitting electrode 132.

Furthermore, the first conductive member 140 is arranged so as to overlap the center portion 132b of the emitting electrode 132 and the power supply point 132a of the emitting electrode 132.

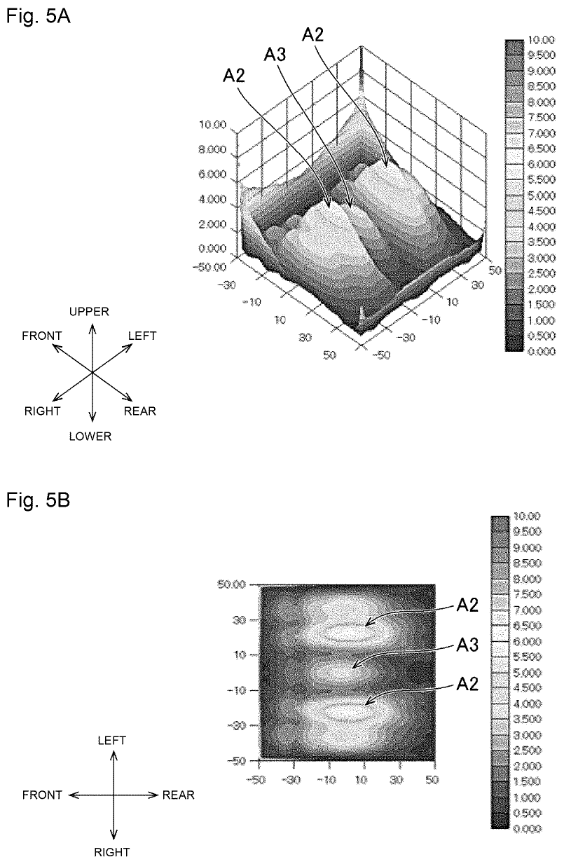

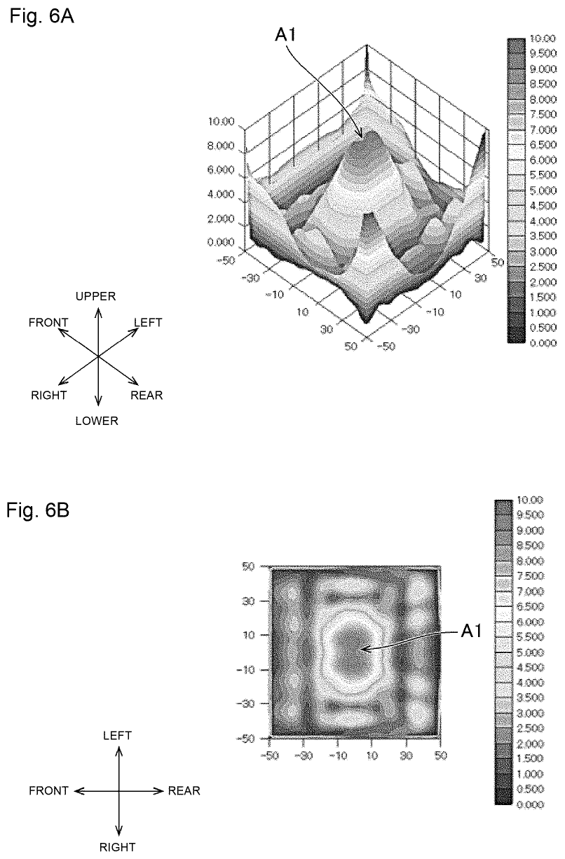

Hereinafter, with reference to FIGS. 5 and 6, an analysis result of electric field distribution on an upper surface of the object A to be heated in a case where the first conductive member 140 is used will be described. The object A to be heated is, for example, frozen rice. The object A to be heated is arranged in a region on the emitting electrode 132, and has a larger area than the emitting electrode 132 when viewed from the first direction. FIG. 5A is a perspective view illustrating an analysis result of electric field distribution on an upper surface of the object A to be heated when the object A to be heated is heated in the heating cooker 10. FIG. 5B is a top view illustrating an analysis result of electric field distribution on an upper surface of the object A to be heated when the object A to be heated is heated in the heating cooker 10. FIG. 6 is a comparative example of FIG. 5. FIG. 6A is a perspective view illustrating an analysis result of electric field distribution on an upper surface of the object A to be heated when the object A to be heated is heated in a mode in which the first conductive member 140 is removed from the heating cooker 10. FIG. 6B is a top view illustrating an analysis result of electric field distribution on an upper surface of the object A to be heated when the object A to be heated is heated in a mode in which the first conductive member 140 is removed from the heating cooker 10.

First, electric field distribution of the object A to be heated in a case where the first conductive member 140 is not provided will be described with reference to FIG. 6. In FIG. 6, it can be confirmed that one first region A1 having high electric field intensity is formed in a central portion of a region on the emitting electrode 132.

Next, electric field distribution of the object A to be heated in a case where the first conductive member 140 is provided will be described with reference to FIG. 5. In FIG. 5, it can be confirmed that second regions A2 having high electric field intensity are formed on both sides in a lateral direction (in the present embodiment, the left-right direction) of the first conductive member 140. Further, it can be confirmed that electric field intensity of the second region A2 illustrated in FIG. 5 is lower than that of the first region A1 illustrated in FIG. 6. Further, a third region A3 sandwiched between two of the second regions A2 illustrated in FIG. 5 is a region located above the first conductive member 140. Since microwaves from the second region A2 propagate around the third region A3, it can be seen that electric field intensity is lowered as compared with the second region A2, but the electric field intensity is secured to some extent.

As described above, when FIGS. 5 and 6 are compared with each other, by providing the first conductive member 140, a region having high electric field intensity can be divided into two regions. Specifically, by providing the first conductive member 140, the first region A1 illustrated in FIG. 6 can be divided into two of the second regions A2 illustrated in FIG. 5. Further, electric field intensity can be secured to some extent also in the third region A3 between two of the second regions A2. As described above, by providing the first conductive member 140, it is possible to divide a region having high electric field intensity, so that it is possible to uniformize electric field distribution. Therefore, local heating can be suppressed, so that occurrence of heating unevenness can be suppressed.

In the above configuration, the first conductive member 140 has a shape in which a polarization direction of the planar antenna 130 is set to a longitudinal direction, and is arranged so as to overlap a part of the emitting electrode 132, so that a region having high electric field intensity can be divided with the emitting electrode 132 interposed between them, so that electric field distribution on the emitting electrode 132 can be uniformized. Therefore, local heating can be suppressed on the emitting electrode 132, so that occurrence of heating unevenness can be suppressed.

Note that, from the viewpoint of dividing a region having high electric field intensity on the emitting electrode 132, the length L1 of the first conductive member 140 in the longitudinal direction (in the present embodiment, in the front-rear direction) is preferably at least a half of the length L2 of the emitting electrode 132 in the longitudinal direction (in the present embodiment, in the front-rear direction) or more. In the present embodiment, the length of a half of the length L2 of the emitting electrode 132 in the longitudinal direction is λ/4 because length of one side of the emitting electrode 132 is λ/2.

Furthermore, from the viewpoint of dividing a region having high electric field intensity on the emitting electrode 132, the length L1 of the first conductive member 140 in the longitudinal direction (in the present embodiment, in the front-rear direction) is more preferably the length L2 of the emitting electrode 132 in the longitudinal direction (in the present embodiment, in the front-rear direction) or more. By the above, the first conductive member 140 can be provided to cross from one end portion (in the present embodiment, a front end portion) to another end portion (in the present embodiment, a rear end portion) in a polarization direction of the emitting electrode 132, so that a region having high electric field intensity can stably be divided on the emitting electrode 132. Furthermore, the length L1 in a longitudinal direction (in the present embodiment, in the front-rear direction) of the first conductive member 140 is more than or equal to the length L2 in the longitudinal direction (in the present embodiment, in the front-rear direction) of the emitting electrode 132, so that positioning in the longitudinal direction of the first conductive member 140 with respect to the emitting electrode 132 does not need to be strictly performed, and therefore assemblability is improved.

Further, the first conductive member 140 is arranged so as to overlap at least one of the center portion 132b of the emitting electrode 132 and the power supply point 132a, so that electric field intensity can be adjusted in a central region easily heated on the emitting electrode 132, and for this reason, electric field distribution on the emitting electrode 132 can be made further uniform.

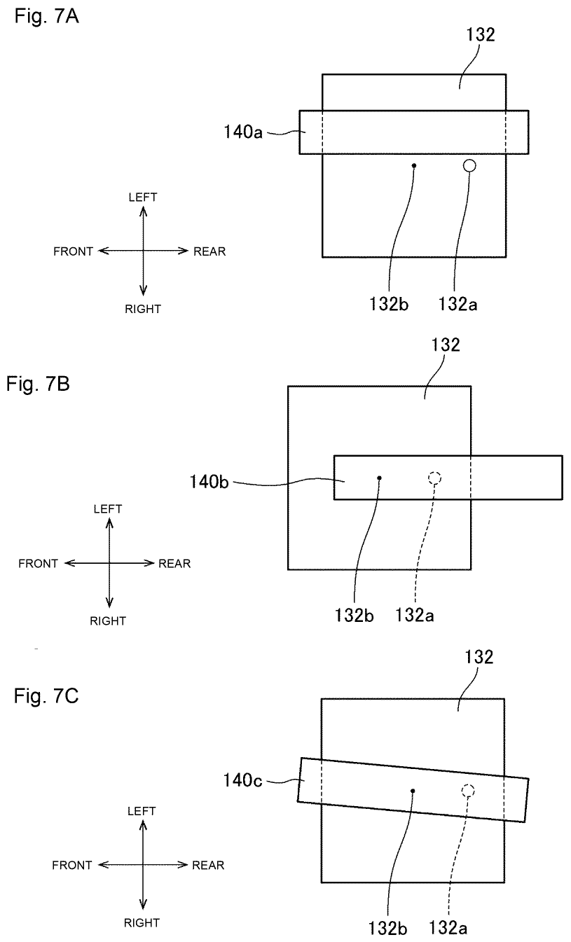

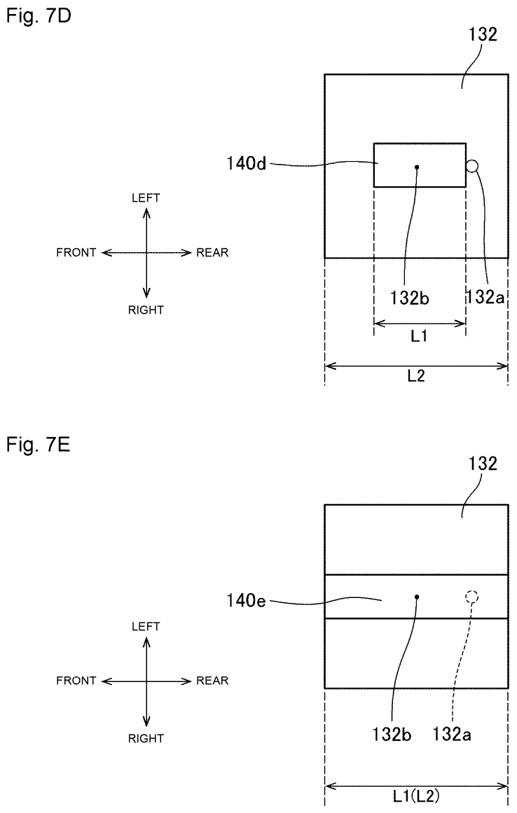

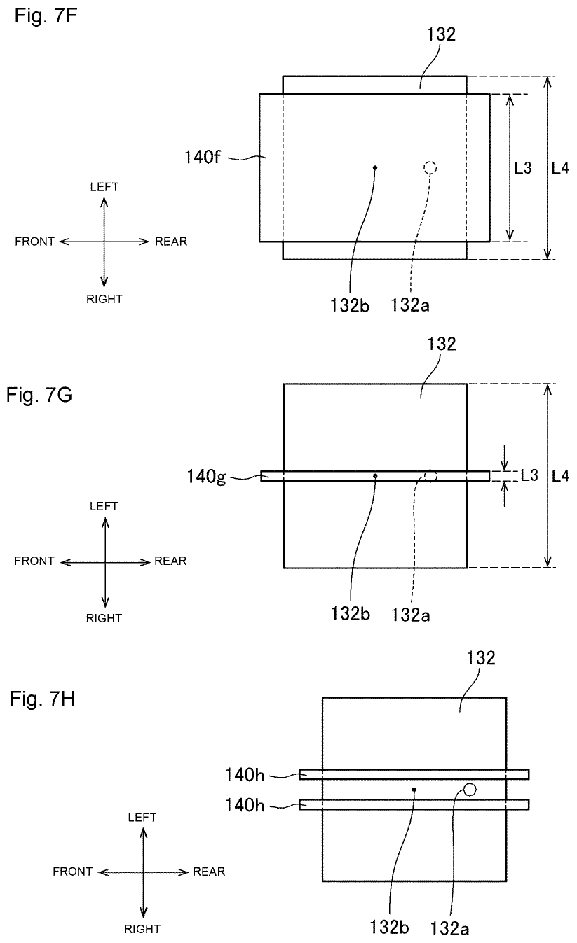

A variation of the first conductive member 140 will be described with reference to FIG. 7. FIG. 7A is a top view illustrating the planar antenna 130 and a first conductive member 140a according to a first variation. FIG. 7B is a top view illustrating the planar antenna 130 and a first conductive member 140b according to a second variation. FIG. 7C is a top view illustrating the planar antenna 130 and a first conductive member 140c according to a third variation. FIG. 7D is a top view illustrating the planar antenna 130 and a first conductive member 140d according to a fourth variation. FIG. 7E is a top view illustrating the planar antenna 130 and a first conductive member 140e as a fifth variation. FIG. 7F is a top view illustrating the planar antenna 130 and a first conductive member 140f according to a sixth variation. FIG. 7G is a top view illustrating the planar antenna 130 and a first conductive member 140g according to a seventh variation. FIG. 7H is a top view illustrating the planar antenna 130 and a first conductive member 140h according to an eighth variation.

The first conductive member 140 preferably overlaps the power supply point 132a and the center portion 132b of the emitting electrode 132 when viewed from the first direction (in the first embodiment, the up-down direction), but the present invention is not limited to this. For example, as illustrated in FIG. 7A, the first conductive member 140a of the first variation may be arranged without overlapping the power supply point 132a and the center portion 132b of the emitting electrode 132 when viewed from the first direction (in the present variation, the up-down direction). Specifically, the first conductive member 140a is arranged at a position shifted upward as compared with the first conductive member 140.

When viewed from the first direction (in the first embodiment, the up-down direction), the first conductive member 140 preferably crosses from one end portion (in the present variation, a front end portion) to another end portion (in the present variation, a rear end portion) in a polarization direction of the emitting electrode 132, but the present invention is not limited to this, and the first conductive member 140 may cross only one end portion or another end portion in the polarization direction, or may not cross an end portion in the polarization direction. For example, as illustrated in FIG. 7B, the first conductive member 140b of the second variation may cross only another end portion (in the present variation, a rear end portion) in a polarization direction of the emitting electrode 132 when viewed from the first direction (in the present variation, the up-down direction). Specifically, the first conductive member 140b is arranged at a position shifted rearward as compared with the first conductive member 140.

A longitudinal direction of the first conductive member 140 is preferably parallel to a polarization direction (in the present variation, in the front-rear direction) of the planar antenna 130, but is not limited to this, and the longitudinal direction may be inclined with respect to the polarization direction of the planar antenna 130. For example, as illustrated in FIG. 7C, a longitudinal direction of the first conductive member 140c may be inclined with respect to a polarization direction (in the present variation, in the front-rear direction) of the emitting electrode 132.

The length L1 in a longitudinal direction of the first conductive member 140 is preferably more than or equal to the length L2 in a longitudinal direction of the emitting electrode 132 when viewed from the first direction (in the first embodiment, the up-down direction), but the present invention is not limited to this, and the length L1 in the longitudinal direction only needs to be more than or equal to a half of the length L2 in the longitudinal direction of the emitting electrode 132. For example, as illustrated in FIG. 7D, the length L1 in the longitudinal direction of the first conductive member 140d may be a half of the length L2 in the longitudinal direction of the emitting electrode 132 when viewed from the first direction (in the present variation, the up-down direction). In this case, the first conductive member 140d preferably entirely overlaps the emitting electrode 132 when viewed from the first direction (in the present variation, the up-down direction). Further, as illustrated in FIG. 7E, the length L1 in the longitudinal direction of the first conductive member 140e may be the length L2 in the longitudinal direction of the emitting electrode 132 when viewed from the first direction (in the present variation, the up-down direction).

When viewed from the first direction (in the first embodiment, the up-down direction), the length L3 in the lateral direction (in the first embodiment, the left-right direction) of the first conductive member 140 only needs to be less than or equal to the length L4 in the lateral direction of the emitting electrode 132. For example, as illustrated in FIG. 7F, the first conductive member 140f may have the length L3 in the lateral direction (in the present variation, the left-right direction) longer than that of the first conductive member 140. Further, as illustrated in FIG. 7G, the first conductive member 140g may have the length L3 in the lateral direction (in the present variation, the left-right direction) shorter than that of the first conductive member 140.

Although one of the first conductive member 140 is provided for one of the emitting electrode 132, the present invention is not limited to this, and for example, a plurality of the first conductive members 140 may be provided for one of the emitting electrode 132. For example, as illustrated in FIG. 7H, two of the first conductive members 140h may be provided for one of the emitting electrode 132. For example, two of the first conductive members 140h are arranged on both sides with the center portion 132b and the power supply point 132a of the emitting electrode 132 interposed between them.

### Second Embodiment

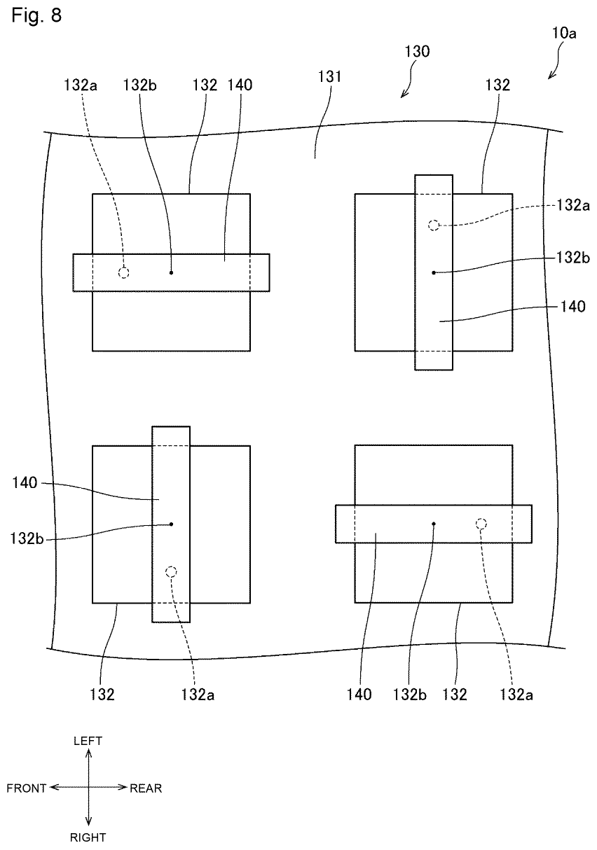

The heating cooker 10a according to a second embodiment will be described with reference to FIG. 8. FIG. 8 is a top view of the planar antenna 130 and the first conductive member 140 of the heating cooker 10a. The heating cooker 10a illustrated in FIG. 8 is different from the first embodiment only in that the planar antenna 130 includes a plurality of the emitting electrodes 132.

The planar antenna 130 includes one of the ground electrode 131 and four of the emitting electrodes 132. Four of the emitting electrodes 132 are arranged in an array on the ground electrode 131 when viewed from the first direction (in the present embodiment, the up-down direction). Specifically, four of the emitting electrodes 132 are arranged in two rows and two columns on the ground electrode 131 when viewed from the first direction (in the present embodiment, the up-down direction). In the present embodiment, a row direction is defined as the left-right direction, and a column direction is defined as the front-rear direction.

Among four of the emitting electrodes 132, the emitting electrodes 132 adjacent to each other in the row direction (in the present embodiment, the left-right direction) or the column direction (in the present embodiment, in the front-rear direction) are arranged such that polarization directions of the emitting electrodes intersect each other. In the present embodiment, polarization directions of the emitting electrodes 132 adjacent to each other in the row direction (in the present embodiment, the left-right direction) or the column direction (in the present embodiment, in the front-rear direction) are orthogonal to each other. For example, a polarization direction of the emitting electrodes 132 located at the upper left and the lower right in the diagram of FIG. 8 is the front-rear direction, and a polarization direction of the emitting electrodes 132 located at the lower left and the upper right in the diagram of FIG. 8 is the left-right direction.

Further, among four of the emitting electrodes 132, the emitting electrodes 132 diagonally adjacent to each other are provided such that the sides on which the power supply point 132a is provided in the polarization direction of the emitting electrodes 132 are opposite to each other. For example, in the diagram of FIG. 8, the emitting electrode 132 located at the upper left is located on one side (front side) in the polarization direction, whereas the emitting electrode 132 located at the lower right is located on another side (rear side) in the polarization direction. Further, in the diagram of FIG. 8, the emitting electrode 132 located at the lower left is located on one side (right side) in the polarization direction, whereas the emitting electrode 132 located at the upper right is located on another side (left side) in the polarization direction.

One of the first conductive member 140 is provided for one of the emitting electrode 132. In the present embodiment, since the planar antenna 130 has four of the emitting electrodes 132, four of the first conductive members 140 are provided. Each of the first conductive members 140 has the same shape as the conductive member of the first embodiment, and will be omitted from description.

Among four of the first conductive members 140, the first conductive members 140 adjacent to each other in the row direction (in the present embodiment, the left-right direction) or the column direction (in the present embodiment, in the front-rear direction) are arranged such that longitudinal directions of the first conductive members 140 intersect with each other. In the present embodiment, longitudinal directions of the first conductive members 140 adjacent to each other in the row direction or the column direction are orthogonal to each other. For example, a longitudinal direction of the first conductive member 140 located at the upper left and the lower right in the diagram of FIG. 8 is the front-rear direction, whereas a longitudinal direction of the first conductive member 140 located at the lower left and the upper right in the diagram of FIG. 8 is the left-right direction. By the above, for example, the first conductive member 140 located at the upper left and the lower right in the diagram of FIG. 8 can divide a region having high electric field intensity in a region on the emitting electrode 132 in the left-right direction, and the first conductive member 140 located at the lower left and the upper right in the diagram of FIG. 8 can divide a region having high electric field intensity in a region on the emitting electrode 132 in the front-rear direction.

As described above, the first conductive members 140 adjacent to each other in the row direction (in the present embodiment, the left-right direction) or the column direction (in the present embodiment, in the front-rear direction) are arranged such that longitudinal directions of the first conductive members 140 intersect each other, and thus, in the emitting electrodes 132 adjacent to each other in the row direction or the column direction, directions in which a region having high electric field intensity is divided can be made different, so that it is possible to uniformize electric field distribution in the entire housing 110. Therefore, local heating in the housing 110 can be suppressed, so that heating unevenness can be suppressed.

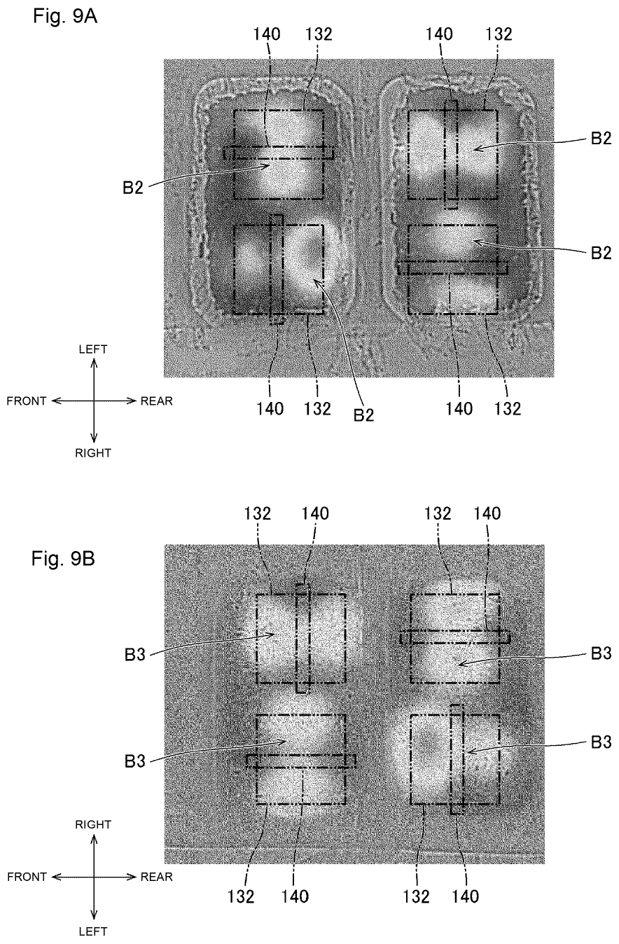

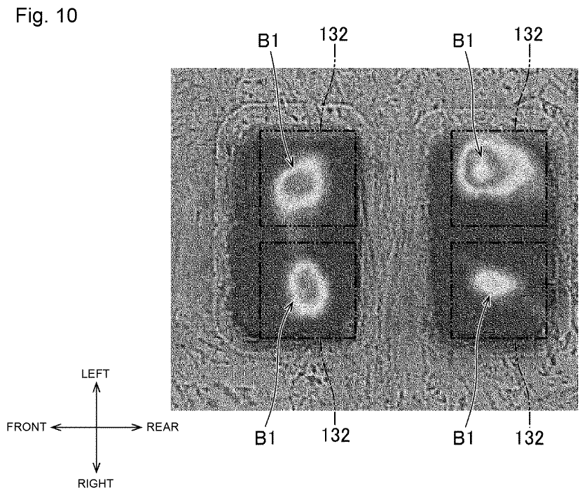

With reference to FIGS. 9 and 10, a result of a heating experiment by the heating cooker 10a will be described. The object A to be heated is, for example, frozen rice. FIG. 9A is a temperature distribution diagram of an upper surface of the object A to be heated when the object A to be heated is heated at a predetermined temperature for predetermined time in the heating cooker 10a. FIG. 9B is a temperature distribution diagram of a bottom surface of the object A to be heated when the object A to be heated is heated at a predetermined temperature for predetermined time in the heating cooker 10a. FIG. 10 is a comparative example of FIG. 9. FIG. 10 is a temperature distribution diagram of an upper surface of the object A to be heated when the object A to be heated is heated at a predetermined temperature for predetermined time in a mode in which the first conductive member 140 is removed from the heating cooker 10a.

In the modes illustrated in FIGS. 9 and 10, two of the objects A to be heated are arranged adjacent to each other in the column direction (in the present embodiment, in the front-rear direction), and each of the objects A to be heated is arranged so as to extend over the emitting electrodes 132 adjacent to each other in the row direction (in the present embodiment, the left-right direction).

First, temperature distribution in a case where the first conductive member 140 is not provided will be described with reference to FIG. 10. In FIG. 10, it can be confirmed that a first region B1 having a high temperature is formed in a central portion on each of the emitting electrodes 132.

Next, temperature distribution in a case where the first conductive member 140 is provided will be described with reference to FIG. 9. In FIG. 9A, it can be confirmed that a second region B2 having a high temperature is formed across the first conductive member 140 on each of the emitting electrodes 132. The second region B2 having a high temperature is a light-colored portion in FIG. 9A. Furthermore, similarly in FIG. 9B, it can be confirmed that a third region B3 having a high temperature is formed across the first conductive member 140 on each of the emitting electrodes 132. The third region B3 having a high temperature is a light-colored portion in FIG. 9B. It can be confirmed that the second region B2 and the third region B3 illustrated in FIG. 9 are wider than the first region B1 illustrated in FIG. 10, and an increase range of temperature is gentle.

As described above, when FIGS. 9 and 10 are compared with each other, by providing the first conductive member 140, a high temperature region can be expanded, and increase in temperature in the region can be made gentle. Therefore, local heating can be suppressed in the entire housing 110, so that heating unevenness can be suppressed.

Note that, in the second embodiment, the planar antenna 130 includes four of the emitting electrodes 132, but the present invention is not limited to this, and for example, the planar antenna 130 only needs to include one or two or more of the emitting electrodes 132. Further, a plurality of the emitting electrodes 132 are arranged in a square lattice shape, but the present invention is not limited to this. For example, a plurality of the emitting electrodes 132 may be arranged in a staggered lattice pattern.

Further, in the first embodiment and the second embodiment, the first conductive member 140 is arranged so as to overlap a part of the emitting electrode 132 when viewed from the first direction (in the above embodiment, the up-down direction), but the present invention is not limited to this, and the first conductive member 140 may be arranged so as not to overlap the emitting electrode 132. Even if the first conductive member 140 does not overlap the emitting electrode 132, electric field intensity can be adjusted at a position where the first conductive member 140 can act on microwaves emitted from the emitting electrode 132, and for this reason, electric field distribution can be made uniform.

### Third Embodiment

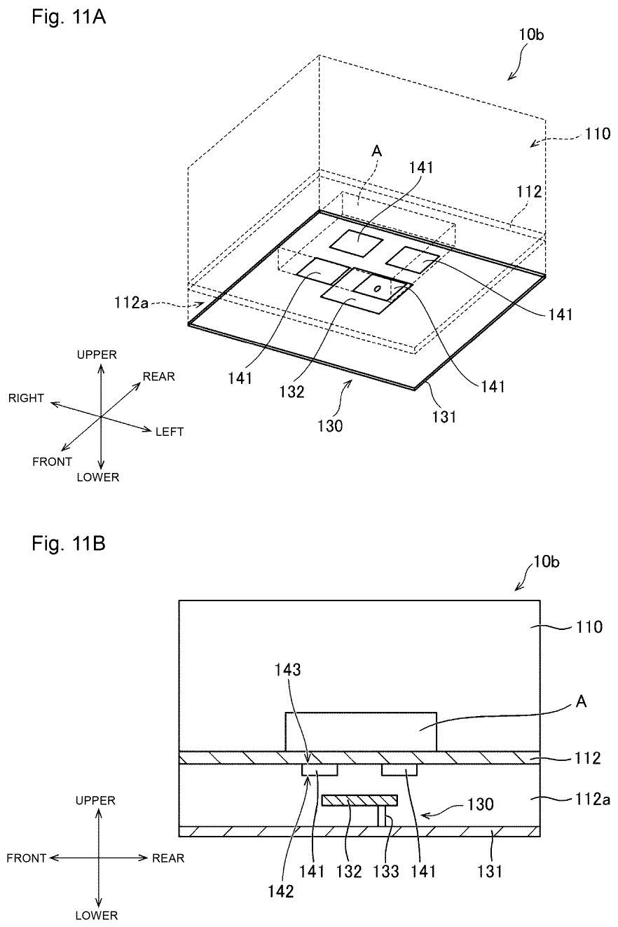

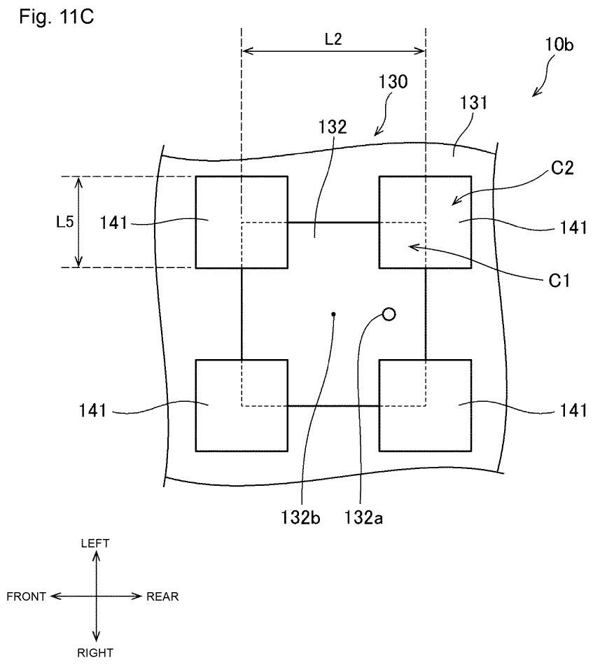

A heating cooker 10b according to a third embodiment will be described with reference to FIG. 11. The heating cooker 10b is different from the heating cooker 10 in that a second conductive member 141 is provided instead of the first conductive member 140. Similarly to the first conductive member 140, the second conductive member 141 acts on microwaves emitted by the planar antenna 130 to adjust electric field intensity in the housing 110. FIG. 11A is a perspective view of the heating cooker 10b illustrating the planar antenna 130 and the second conductive member 141. In FIG. 11A, the door 12 is not illustrated. In FIG. 11A, a member other than the planar antenna 130 and the second conductive member 141 is indicated by a broken line. FIG. 11B is a cross-sectional view of the heating cooker 10b illustrating the planar antenna 130 and the second conductive member 141. FIG. 11B is a cross-sectional view taken along a vertical plane along the front-rear direction passing through the center portion 132b of the emitting electrode 132. FIG. 11C is a top view of the planar antenna 130 and the second conductive member 141. The planar antenna 130 includes one of the ground electrode 131 and one of the emitting electrode 132. Hereinafter, only a difference from the heating cooker 10 of the first embodiment will be described.

As illustrated in FIG. 11, four of the second conductive members 141 are provided for one of the emitting electrode 132. The second conductive member 141 is, for example, a flat plate having a square shape. The second conductive member 141 is formed of, for example, copper.

The second conductive member 141 is provided between the planar antenna 130 and a transmitting portion (the lower wall portion 112). The second conductive member 141 is fixed to a lower surface of the transmitting portion (lower wall portion 112) with an adhesive member such as Kapton tape.

As illustrated in FIG. 11C, the second conductive member 141 is arranged to overlap a part of the emitting electrode 132 when viewed from the first direction (in the present embodiment, the up-down direction).

Specifically, the second conductive member 141 is provided not to overlap the center portion 132b of the emitting electrode 132 but to overlap an outer peripheral portion of the emitting electrode 132. Further, the second conductive member 141 includes a region C1 overlapping the emitting electrode 132 and a region C2 not overlapping the emitting electrode 132 when viewed from the first direction (in the present embodiment, the up-down direction). Further, preferably, the second conductive member 141 does not overlap the power supply point 132a of the emitting electrode 132.

The second conductive member 141 has a first surface 142 on the emitting electrode 132 side and a second surface 143 on a transmitting portion (the lower wall portion 112) side. A part of the first surface 142 faces the emitting electrode 132 in the up-down direction. The second surface 143 is in contact with the transmitting portion (lower wall portion 112).

Size (area) of the second conductive member 141 is smaller than size (area) of the emitting electrode 132. That is, length L5 of one side of the second conductive member 141 is smaller than the length L2 of one side of the emitting electrode 132. Further, when viewed from the first direction (in the present embodiment, the up-down direction), a direction in which each side of the second conductive member 141 extends is the same direction as each side of the emitting electrode 132.

In the present embodiment, four of the second conductive members 141 are arranged at intervals along an outer peripheral portion of the emitting electrode 132 when viewed from the first direction (in the present embodiment, the up-down direction). Four of the second conductive members 141 are arranged at vertices of the emitting electrode 132 formed in a square shape. In the present embodiment, a center portion of each of the second conductive members 141 is arranged so as to overlap each vertex of the emitting electrode 132. That is, when viewed from the first direction (in the present embodiment, the up-down direction), in the second conductive member 141, the region C2 not overlapping the emitting electrode 132 is larger than the region C1 overlapping the emitting electrode 132.

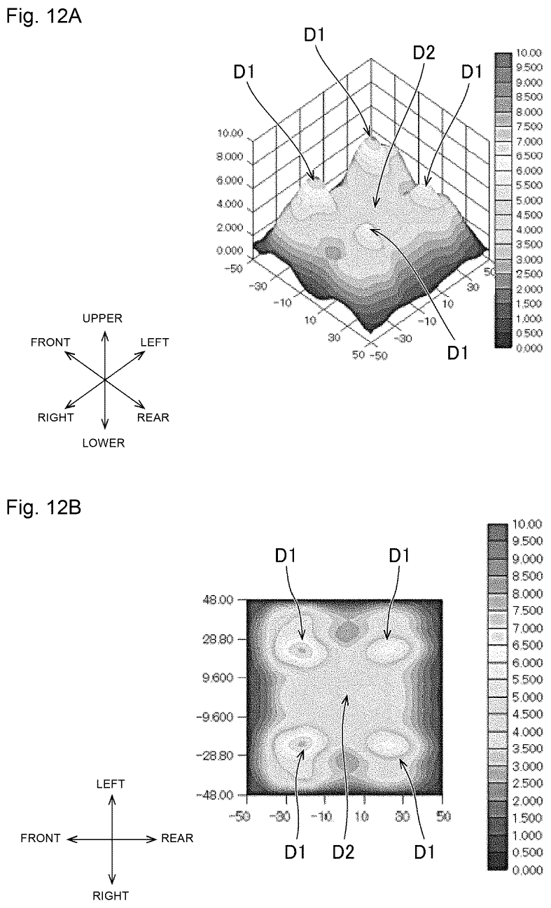

Hereinafter, with reference to FIGS. 6 and 12, an analysis result of electric field distribution on an upper surface of the object A to be heated in a case where the second conductive member 141 is used will be described. The object A to be heated is, for example, frozen rice. The object A to be heated is arranged in a region on the emitting electrode 132, and has a larger area than the emitting electrode 132 when viewed from the first direction. FIG. 12A is a perspective view illustrating an analysis result of electric field distribution on an upper surface of the object A to be heated when the object A to be heated is heated in the heating cooker 10b. FIG. 12B is a top view illustrating an analysis result of electric field distribution on an upper surface of the object A to be heated when the object A to be heated is heated in the heating cooker 10b. FIG. 6 is a comparative example of FIG. 12.

First, electric field distribution of the object A to be heated in a case where the second conductive member 141 is not provided will be described with reference to FIG. 6. In FIG. 6, it can be confirmed that one of the first region A1 having high electric field intensity is formed in a central portion of a region on the object A to be heated.

Next, electric field distribution of the object A to be heated in a case where the second conductive member 141 is provided will be described with reference to FIG. 12. In FIG. 12, it can be confirmed that a fourth region D1 having high electric field intensity is formed in a region on each of the second conductive members 141. Further, it can be confirmed that electric field intensity of the fourth region D1 illustrated in FIG. 12 is lower than that of the first region A1 illustrated in FIG. 6. Furthermore, in a fifth region D2 surrounded by the fourth region D1 illustrated in FIG. 12, microwaves from the fourth region D1 propagate, and thus, it can be seen that electric field intensity is lowered as compared with the fourth region D1, but the electric field intensity is secured to some extent.

As described above, when FIGS. 6 and 12 are compared with each other, a region having high electric field intensity can be generated by providing the second conductive member 141. Specifically, the fourth region D1 illustrated in FIG. 12 can be generated by providing the second conductive member 141. Further, electric field intensity can be secured to some extent also in the fifth region D2 surrounded by four of the fourth regions D1. As described above, by providing the second conductive member 141, a region having high electric field intensity can be generated on the second conductive member 141, so that electric field distribution can be made uniform. Therefore, local heating can be suppressed, so that occurrence of heating unevenness can be suppressed.

In the above configuration, when viewed from the first direction (in the present embodiment, the up-down direction), the second conductive member 141 is provided so as not to overlap the center portion 132b of the emitting electrode 132 but to overlap an outer peripheral portion of the emitting electrode 132, so that a region having high electric field intensity can be generated on an outer peripheral portion of the emitting electrode 132. This is because the first surface 142 of the second conductive member 141 functions as a surface that receives microwaves emitted from the emitting electrode 132, and the second surface 143 of the second conductive member 141 functions as a surface that emits microwaves received on the first surface 142, so that electric field intensity on the second conductive member 141 can be increased by microwaves re-emitted through the second conductive member 141. For this reason, by providing the second conductive member 141 on an outer peripheral portion of the emitting electrode 132 where electric field intensity is weakened, electric field distribution on the emitting electrode 132 can be made uniform, so that occurrence of heating unevenness can be suppressed.

Further, in the second conductive member 141, when viewed from the first direction (in the present embodiment, the up-down direction), the region C2 that does not overlap the emitting electrode 132 is larger than the region C1 that overlaps an emitting element (the emitting electrode 132), so that microwaves received from the first surface 142 can be re-emitted from the second surface 143 to the outer side (peripheral side) of the emitting electrode 132, and for this reason, electric field distribution can be further made uniform.

Note that the length L5 of one side of the second conductive member 141 is preferably ⅖ or more of the length L2 of one side of the emitting electrode 132 from the viewpoint of generating a region having high electric field intensity on the emitting electrode 132. In the present embodiment, the length of ⅖ of the length L2 of one side of the emitting electrode 132 is λ/5 because length of one side of the emitting electrode 132 is λ/2.

Further, in the second conductive member 141, the length L5 of one side is preferably ⅔ or less of the length L2 of one side of the emitting electrode 132 from the viewpoint of preventing a reflection amount of microwaves in the second conductive member 141 from becoming too large. In the present embodiment, the length of ⅔ of the length L2 of one side of the emitting electrode 132 is λ/3 because length of one side of the emitting electrode 132 is λ/2.

Further, by providing a plurality of the second conductive members 141 at intervals along an outer peripheral portion of the emitting electrode 132, it is possible to generate regions having high electric field intensity as many as the number of the second conductive members 141, so that it is possible to further uniformize electric field distribution on the emitting electrode 132.

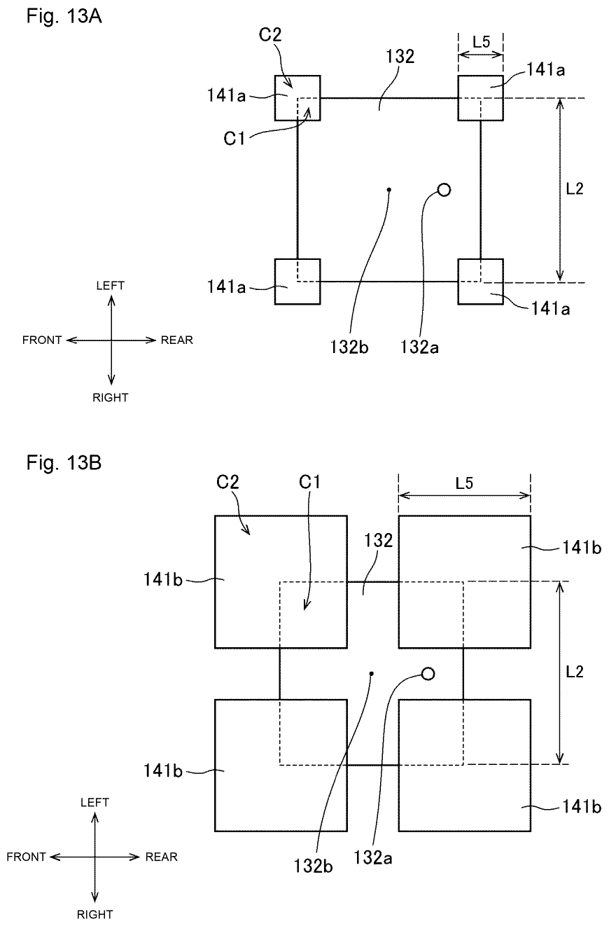

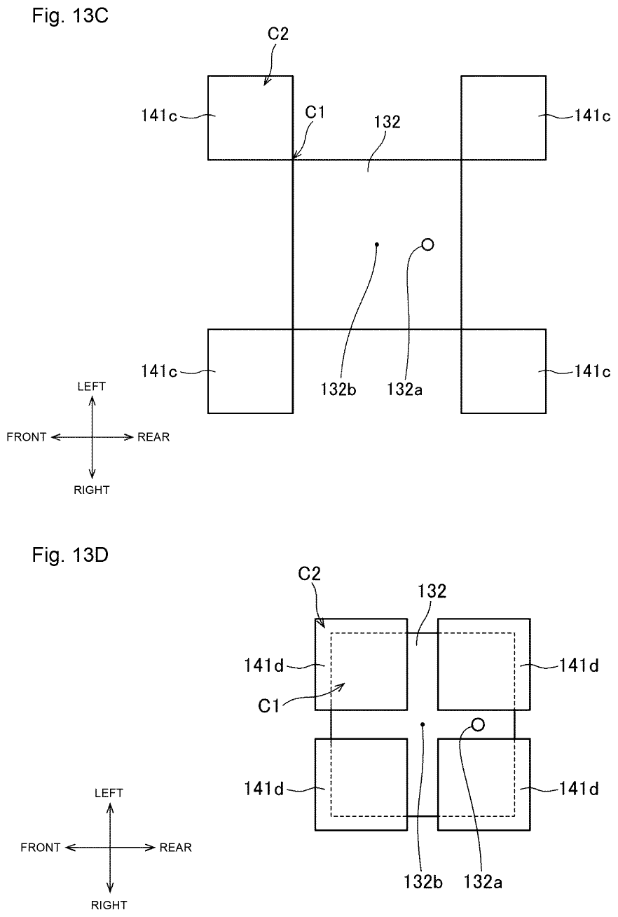

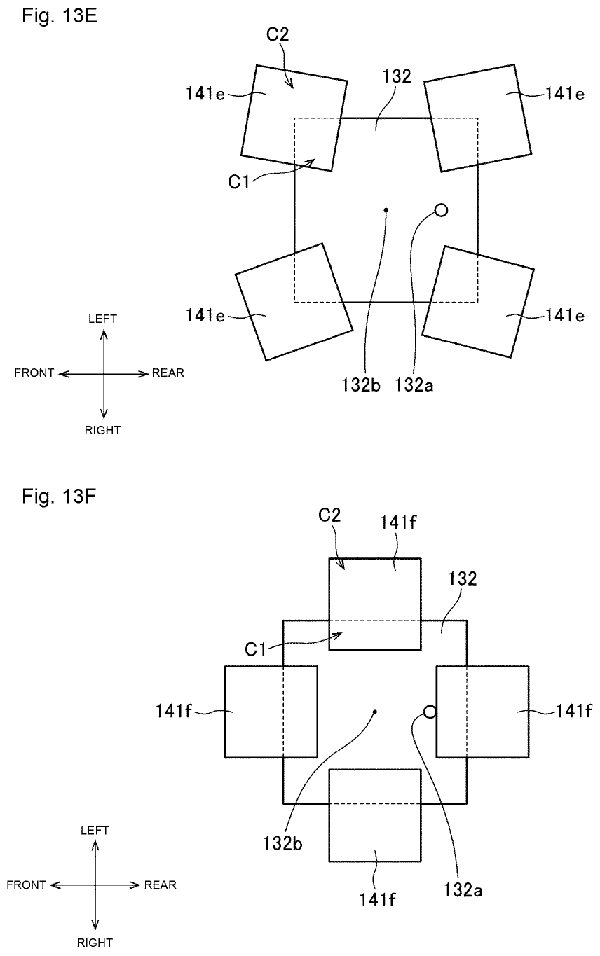

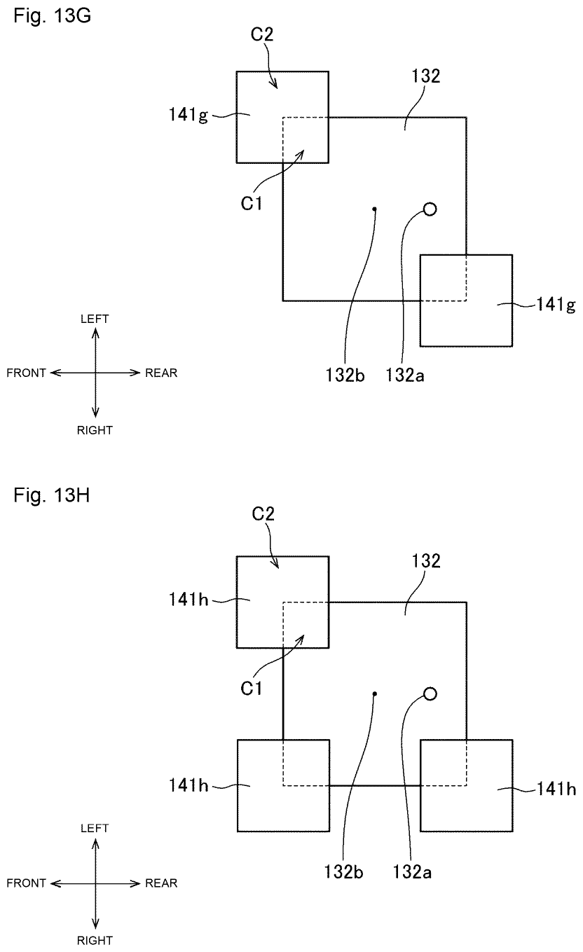

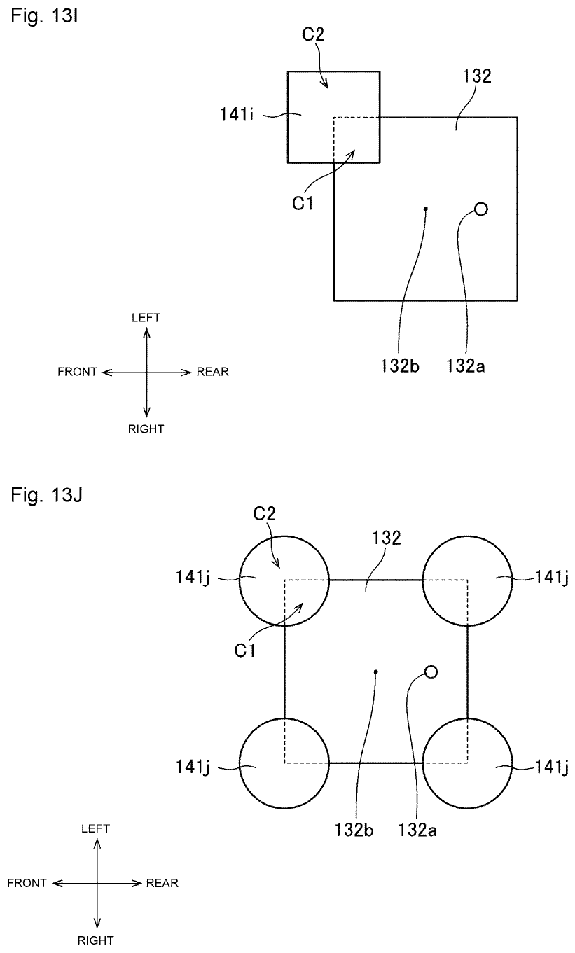

A variation of the second conductive member 141 will be described with reference to FIG. 13. FIG. 13A is a top view illustrating the planar antenna 130 and a second conductive member 141a according to a first variation. FIG. 13B is a top view illustrating the planar antenna 130 and a second conductive member 141b according to a second variation. FIG. 13C is a top view illustrating the planar antenna 130 and a second conductive member 141c according to a third variation. FIG. 13D is a top view illustrating the planar antenna 130 and a second conductive member 141d according to a fourth variation. FIG. 13E is a top view illustrating the planar antenna 130 and a second conductive member 141e according to a fifth variation. FIG. 13F is a top view illustrating the planar antenna 130 and a second conductive member 141f according to a sixth variation. FIG. 13G is a top view illustrating the planar antenna 130 and a second conductive member 141g according to a seventh variation. FIG. 13H is a top view illustrating the planar antenna 130 and a second conductive member 141h according to an eighth variation. FIG. 13I is a top view illustrating the planar antenna 130 and a second conductive member 141i according to a ninth variation. FIG. 13J is a top view illustrating the planar antenna 130 and a second conductive member 141j according to a tenth variation.

When viewed from the first direction (in the third embodiment, the up-down direction), the second conductive member 141 only needs to have size (area) that does not overlap the center portion 132b and the power supply point 132a of the emitting electrode 132. For example, as illustrated in FIG. 13A, size (area) of the second conductive member 141a may be reduced by reducing the length L5 of one side of the second conductive member 141a. Further, as illustrated in FIG. 13B, size (area) of the second conductive member 141b may be increased by increasing the length L5 of one side of the second conductive member 141b.

In the second conductive member 141, when viewed from the first direction (in the third embodiment, the up-down direction), the region C2 not overlapping the emitting electrode 132 is preferably larger than the region C1 overlapping the emitting electrode 132, and a ratio of the region C1 overlapping the emitting electrode 132 to the region C2 not overlapping the emitting electrode 132 is preferably about ⅓, but the ratio is not limited to this. For example, as illustrated in FIG. 13C, a ratio of the region C1 overlapping the emitting electrode 132 to the region C2 not overlapping the emitting electrode 132 in the second conductive member 141c may be less than ⅓. Further, as illustrated in FIG. 13D, the region C2 not overlapping the emitting electrode 132 in the second conductive member 141d may be smaller than the region C1 overlapping the emitting electrode 132.

In the second conductive member 141, when viewed from the first direction (in the third embodiment, the up-down direction), an extending direction of each side is the same as each side of the corresponding emitting electrode 132, but the present invention is not limited to this. For example, as illustrated in FIG. 13E, the second conductive member 141e may be arranged so as to be rotated about its center portion as compared with the second conductive member 141, so that an extending direction of each side may be different from an extending direction of each side of the corresponding emitting electrode 132.

The second conductive member 141 is preferably arranged at a vertex of the emitting electrode 132 when viewed from the first direction (in the third embodiment, the up-down direction), but is not limited to this. For example, as illustrated in FIG. 13F, the second conductive member 141f may be arranged on a side connecting vertices of the emitting electrode 132. In FIG. 13F, four of the second conductive members 141f are arranged on four sides connecting vertices of the emitting electrode 132.

In a case where the emitting electrode 132 is formed in a square shape, the number of the second conductive members 141 is preferably equal to the number corresponding to vertices of the emitting electrode 132, but is not limited to this. For example, as illustrated in FIG. 13G, two of the second conductive members 141g may be arranged at two vertices facing each other of the emitting electrode 132, as illustrated in FIG. 13H, three of the second conductive members 141h may be arranged at vertices excluding one optional vertex of the emitting electrode 132, or as illustrated in FIG. 13I, one of the second conductive member 141i may be arranged at one optional vertex.

The second conductive member 141 has a square shape when viewed from the first direction (in the third embodiment, the up-down direction), but is not limited to this. For example, as illustrated in FIG. 13J, the shape may be a circular shape when viewed from the first direction (in the present variation, the up-down direction). Further, the second conductive member 141 is not limited to a circular shape, and may have an elliptical shape or a polygonal shape.

Note that, in the third embodiment, the second conductive member 141 is arranged so as to overlap a part of the emitting electrode 132 when viewed from the first direction (in the above embodiment, the up-down direction), but the present invention is not limited to this, and the second conductive member 141 may be arranged so as not to overlap the emitting electrode 132. Even if the second conductive member 141 does not overlap the emitting electrode 132, electric field intensity can be adjusted at a position where the second conductive member 141 can act on microwaves emitted from the emitting electrode 132, and for this reason, electric field distribution can be made uniform.

Further, although the planar antenna 130 has one of the emitting electrode 132 in the third embodiment, the present invention is not limited to this, and the planar antenna 130 may have a plurality of the emitting electrodes 132 as in the second embodiment.

Further, in the first to third embodiments, the first conductive member 140 or the second conductive member 141 is used as a conductive member, but the present invention is not limited to this, and at least one of the first conductive member 140 and the second conductive member 141 only needs to be used, and the first conductive member 140 and the second conductive member 141 may be used in combination as the conductive member.

### Summary

A microwave heating device (the heating cooker 10, the heating cooker 10a, and the heating cooker 10b) includes the housing 110 having a transmitting portion (the lower wall portion 112) that transmits microwaves, a microwave emitting portion (the planar antenna 130) that is provided outside the housing 110 so as to face the transmitting portion (lower wall portion 112) and emits microwaves, and a conductive member (at least one of the first conductive member 140 and the second conductive member 141) provided between the transmitting portion (lower wall portion 112) and the microwave emitting portion (planar antenna 130).

By the above, the conductive member can act on microwaves emitted from the planar antenna 130 to adjust electric field intensity in the housing 110. Therefore, by uniformizing electric field distribution in the housing 110, local heating can be suppressed, and occurrence of heating unevenness can be suppressed.

The microwave emitting portion (planar antenna 130) includes an emitting element (the emitting electrode 132) having a flat plate shape. A combination of the emitting element having a flat plate shape and the conductive member can suppress local heating.

The conductive member (at least one of the first conductive member 140 and the second conductive member 141) has an area smaller than that of the emitting element (emitting electrode 132) when viewed from a direction (up-down direction) in which the transmitting portion (lower wall portion 112) faces the emitting element (emitting electrode 132). When the conductive member is configured to have an area smaller than that of the emitting element, it is possible to reduce the possibility that the conductive member blocks an electromagnetic wave.

The conductive member (at least one of the first conductive member 140 and the second conductive member 141) overlaps a part of the emitting element (emitting electrode 132) when viewed from a direction (up-down direction) in which the transmitting portion (lower wall portion 112) faces the emitting element (emitting electrode 132). By the above, electric field distribution in a region on the emitting element (emitting electrode 132) can be made uniform.

The emitting element (emitting electrode 132) has a square shape when viewed from a direction (up-down direction) in which the transmitting portion (lower wall portion 112) faces the emitting element (emitting electrode 132). A combination of the emitting element having a square shape and the conductive member can suppress local heating.

The conductive member includes the first conductive member 140 having a shape in which a polarization direction (front-rear direction) of the emitting element (emitting electrode 132) is a longitudinal direction when viewed from a direction (up-down direction) in which the transmitting portion (lower wall portion 112) faces the emitting element (emitting electrode 132). By the above, a region having high electric field intensity on the emitting element (emitting electrode 132) can be divided by the first conductive member 140.

The first conductive member 140 has length equal to or more than a half of length of the emitting element (emitting electrode 132) in a longitudinal direction of the first conductive member 140. The first conductive member 140 has length equal to or more than that of the emitting element (emitting electrode 132) in a longitudinal direction of the first conductive member 140. The first conductive member 140 is provided to cross from one end portion to another end portion in a polarization direction (front-rear direction) of the emitting element (emitting electrode 132) when viewed from a direction (up-down direction) in which the transmitting portion (lower wall portion 112) faces the emitting element (emitting electrode 132). Since the first conductive member 140 can be arranged to cross the emitting element (emitting electrode 132), electric field distribution can be made uniform on the emitting electrode 132. Furthermore, since it is not necessary to strictly perform positioning with respect to a longitudinal direction of the first conductive member 140 with respect to emitting electrode 132, assemblability is improved.

The first conductive member 140 has length shorter than that of the emitting element (emitting electrode 132) in a lateral direction (front-rear direction) of the first conductive member 140. The emitting electrode 132 is provided to extend on both sides in a lateral direction (the front-rear direction) of the first conductive member 140. By the above, it is possible to divide a region having high electric field intensity with the first conductive member 140 interposed between regions on the emitting element (emitting electrode 132).

The first conductive member 140 is provided so as to overlap the power supply point 132a of the emitting element (emitting electrode 132) when viewed from a direction (up-down direction) in which the transmitting portion (lower wall portion 112) faces the emitting element (emitting electrode 132). Since the first conductive member 140 is arranged so as to overlap the power supply point 132a of the emitting electrode 132, electric field intensity can be adjusted in a central region easily heated on the emitting electrode 132, so that electric field distribution on the emitting electrode 132 can be made uniform.

The conductive member includes the second conductive member 141 provided so as not to overlap the center portion 132b of the emitting element (emitting electrode 132) but to overlap the emitting element (emitting electrode 132) when viewed from a direction (up-down direction) in which the transmitting portion (lower wall portion 112) faces the emitting element (emitting electrode 132). The second conductive member 141 has the region C1 overlapping the emitting element (emitting electrode 132) and the region C2 not overlapping the emitting element (emitting electrode 132) when viewed from a direction (up-down direction) in which the transmitting portion (lower wall portion 112) faces the emitting element (emitting electrode 132). By the above, a region having high electric field intensity can be generated in an outer peripheral portion of the emitting electrode 132 which is a region having low electric field intensity, so that electric field distribution on the emitting electrode 132 can be made uniform.

In the second conductive member 141, when viewed from a direction (up-down direction) in which the transmitting portion (lower wall portion 112) faces the emitting element (emitting electrode 132), the region C2 not overlapping the emitting element (emitting electrode 132) is larger than the region C1 overlapping the emitting element (emitting electrode 132). By the above, microwaves can effectively be re-emitted toward the outside (peripheral side) of the emitting electrode 132, so that electric field distribution can be made uniform.

A conductive member includes a plurality of the second conductive members 141. Each of a plurality of the second conductive members 141 is arranged at intervals along an outer peripheral portion of the emitting element (emitting electrode 132). By providing a plurality of the second conductive members 141 at intervals along an outer peripheral portion of the emitting electrode 132, it is possible to generate regions having high electric field intensity as many as the number of the second conductive members 141, so that it is possible to uniformize electric field distribution on the emitting electrode 132.

Note that the present invention is not limited to the above embodiment, and various modifications are possible. For example, the configuration can be replaced with a configuration substantially identical to the configuration described in the above embodiment, a configuration having the same function and effect, or a configuration capable of achieving the same purpose. Further, some or all of the embodiments of the present invention may be used in combination.

1. A microwave heating device comprising:
a housing having a transmitting portion that transmits a microwave;
a microwave emitting portion that is provided in a manner facing the transmitting portion outside the housing and configured to emit a microwave; and
a conductive member provided between the transmitting portion and the microwave emitting portion.

2. The microwave heating device according to claim 1, wherein the microwave emitting portion includes an emitting element having a flat plate shape.

3. The microwave heating device according to claim 2, wherein the conductive member has an area smaller than an area of the emitting element when viewed from a direction in which the transmitting portion faces the emitting element.

4. The microwave heating device according to claim 2, wherein the conductive member overlaps a part of the emitting element when viewed from a direction in which the transmitting portion faces the emitting element.

5. The microwave heating device according to claim 2, wherein the emitting element has a square shape when viewed from a direction in which the transmitting portion faces the emitting element.

6. The microwave heating device according to claim 2, wherein the conductive member includes a first conductive member having a shape in which a polarization direction of the emitting element is a longitudinal direction when viewed from a direction in which the transmitting portion faces the emitting element.

7. The microwave heating device according to claim 6, wherein the first conductive member has a length equal to or more than a half of a length of the emitting element in the longitudinal direction thereof.

8. The microwave heating device according to claim 6, wherein the first conductive member has a length equal to or more than a length of the emitting element in the longitudinal direction thereof.

9. The microwave heating device according to claim 6, wherein the first conductive member is provided to cross from one end portion to another end portion in the polarization direction of the emitting element when viewed from the direction in which the transmitting portion faces the emitting element.

10. The microwave heating device according to claim 6, wherein the first conductive member has a length shorter than a length of the emitting element in a lateral direction thereof.

11. The microwave heating device according to claim 6, wherein the first conductive member is provided with the emitting element extending on both sides in a lateral direction thereof.

12. The microwave heating device according to claim 6, wherein the first conductive member is provided so as to overlap a power supply point of the emitting element when viewed from the direction in which the transmitting portion faces the emitting element.

13. The microwave heating device according to claim 2, wherein the conductive member includes a second conductive member provided so as not to overlap a center portion of the emitting element and so as to overlap the emitting element when viewed from a direction in which the transmitting portion faces the emitting element, and
the second conductive member has a region overlapping the emitting element and a region not overlapping the emitting element when viewed from the direction in which the transmitting portion faces the emitting element.

14. The microwave heating device according to claim 13, wherein in the second conductive member, the region that does not overlap the emitting element is larger than the region that overlaps the emitting element when viewed from the direction in which the transmitting portion faces the emitting element.

15. The microwave heating device according to claim 13, wherein
the conductive member includes a plurality of second conductive members, and
the plurality of second conductive members are arranged at intervals along an outer peripheral portion of the emitting element.
